(19) United States
(12) Patent Application Publication
(10) Pub. No.: US 2014/0149296 A1
(43) Pub. Date: May 29, 2014

(54) ENHANCED PREVENTATIVE MAINTENANCE UTILIZING DIRECT PART MARKING

(71) Applicant: Applied Materials, Inc., Santa Clara, CA (US)

(72) Inventors: DC Chang, San Jose, CA (US); Steven Robert Schauer, San Jose, CA (US)

(73) Assignee: Applied Materials, Inc., Santa Clara, CA (US)

(21) Appl. No.: 14/080,704

(22) Filed: Nov. 14, 2013

Related U.S. Application Data
(60) Provisional application No. 61/731,335, filed on Nov. 29, 2012.

(51) Int. Cl. G06Q 10/00

(52) U.S. Cl. CPC G06Q 10/20
USPC 705/305

(57) ABSTRACT

Systems and methods are discussed for use in preventative maintenance and repair systems for semiconductor fabrication equipment. Each semiconductor fabrication system and its replacement components are marked with a unique identification so they may be individually tracked and managed. Data is associated with each fabrication system and component. A component management terminal accesses the data to facilitate preventative maintenance and repair of the semiconductor fabrication equipment.

### CROSS-REFERENCES TO RELATED APPLICATIONS

This application claims priority to Provisional Application No. 61/731,335, filed Nov. 29, 2012, titled “ENHANCED PREVENTATIVE MAINTENANCE UTILIZING DIRECT PART MARKING”, which is hereby incorporated by reference in its entirety.

### BACKGROUND

In the semiconductor fabrication industry there are a number of circumstances unique to this particular field that make the maintenance and repair of semiconductor fabrication equipment a challenge. In general there is a need to minimize downtime of the fabrication equipment as the capital costs are unusually high, thus repairs and maintenance should be planned and brief.

Further, semiconductor fabrication equipment is also typically customized to each particular application, thus it is seldom that two pieces of equipment are built with identical components. An added complication is that many semiconductor fabrication equipment components may look similar to the untrained eye, however subtle differences may result in the system working as designed or not working at all. These conditions may result in maintenance technicians installing the incorrect component, culminating in increased downtime of the equipment.

An added complication is that poorly trained third party vendors are often used for general maintenance and repair to minimize maintenance costs. Poorly trained technicians may have a more difficult time recognizing subtle differences in components and may not access the appropriate technical guides to perform the repair correctly. These conditions may result in installation of incorrect replacement components, or the incorrect installation of the correct components, culminating in increased downtime of the equipment.

There are a number of replacement component marking schemes that can be used to label components so they may be identified correctly. There are also online platforms that can be used to order components. In addition there are a number of manuals and online resources showing components within a machine, installation processes, recipe manuals, etc. While these systems exist, they are not available in a mobile platform available to the technician on-site, and they are not integrated in a serviceable way to insure the correct component is installed on the correct piece of equipment using the correct process. Additionally, none of these systems integrate a preventative maintenance program that tracks the life of the components so they may be replaced before catastrophic failure occurs.

### SUMMARY

Methods using direct component marking for enhanced preventative maintenance systems and for the repair of semiconductor fabrication equipment are described. In some embodiments a replacement component may be marked with a unique identification and data about that component may be associated with that unique identification. In further embodiments, a semiconductor fabrication tool may also have a unique equipment identification and data about that tool may be associated with that unique identification.

In an embodiment, a preventative maintenance system may be used to associate a particular component with a particular semiconductor fabrication tool. A terminal may be used on-site to read the equipment identification and the replacement component identification. The terminal may retrieve associated data from a database for the component and/or the semiconductor fabrication tool. In some embodiments the component may be installed and the terminal may receive input corresponding to the usage rate of the semiconductor fabrication tool. The terminal may generate an alert corresponding to an upcoming maintenance requirement associated with the component so it may be replaced before its predicted failure.

In other embodiments, before the component is installed, the terminal may perform a compatibility assessment of the component and the semiconductor fabrication tool and/or may provide information aiding in the replacement of the component.

In further embodiments, the preventative maintenance system may be used to capture electronic data from the semiconductor processing tool, provide real time access to technical guides, service history, and/or trouble shooting tips, and provide automated transfer of files between a service entity and a client.

In some embodiments, the preventative maintenance system can provide directly marked component tracking. This can include, for example, directly marking components with unique component numbers and providing streamlined component ordering through the preventative maintenance system.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 is an example method for incoming components according to some embodiments;

FIG. 2 is an example method for a preventative maintenance process according to some embodiments;

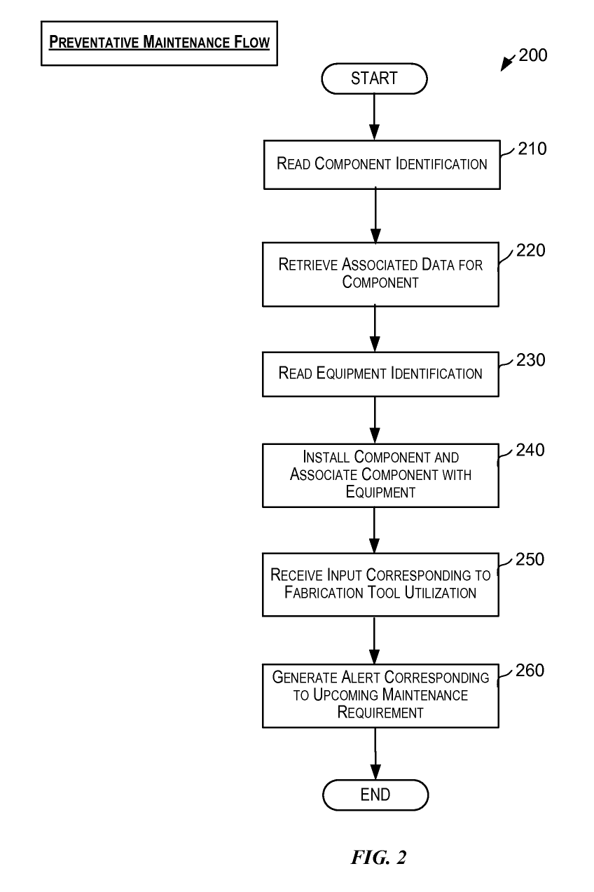

FIG. 3 is an example method for repair and compatibility assessment according to some embodiments;

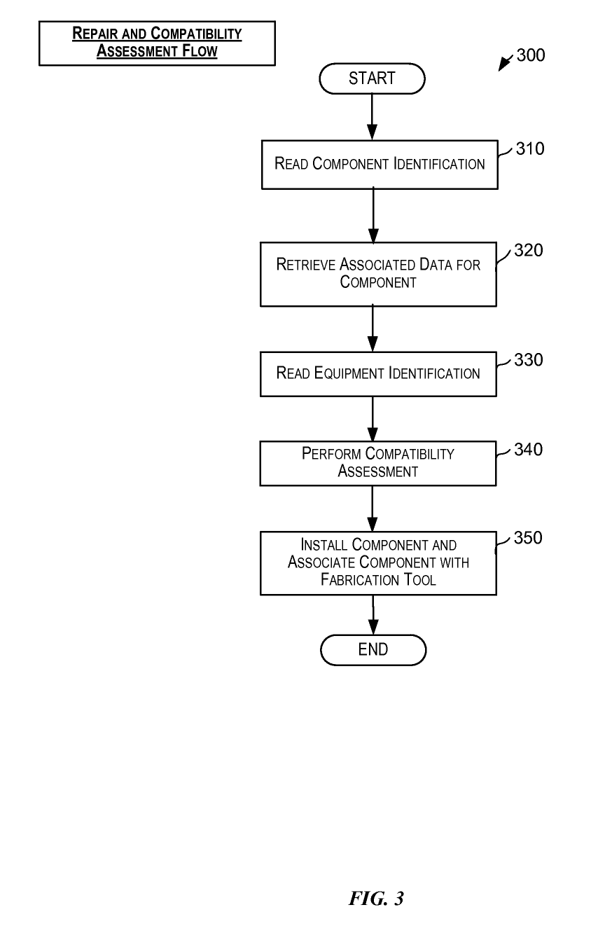

FIG. 4 is a schematic diagram of an embodiment of a service entity system connected to a client system according to some embodiments.

FIG. 5 is an example method for a preventative maintenance process according to some embodiments.

FIG. 6 is an example method for a repair and compatibility process according to some embodiments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below.

Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Embodiments of the invention provide for enhanced preventative maintenance and repair of semiconductor fabrication equipment utilizing direct component marking techniques. This can be done, for example, for semiconductor fabrication equipment where replacement components are individually marked and managed. In some embodiments, components in a semiconductor processing system can be marked using any type of direct component marking process such as, but not limited to, dot peening, laser etching, electro-chemical etching, electro print marking, and/or ink jet printing.

In some embodiments, directly marked components may aid in executing preventative maintenance programs while in other embodiments directly marked components may aid in the reliable repair of semiconductor manufacturing equipment. Directly marked components may improve the ability to track and replace components on individual and unique preventative maintenance schedules, tailored to each component. Further, directly marked components may improve the ability to differentiate between replacement components may look similar, but may have subtle differences that affect their performance. In other embodiments, directly marked components may be used to identify a component that may be custom manufactured to the unique requirements of a particular piece of equipment. In further embodiments, directly marked components may facilitate the tracking of components that are initially used on a first piece of equipment with very tight process controls, and after a certain amount of wear the components may be transferred to a second piece of equipment with less stringent process controls. The unique mark on each component may be used in these and other scenarios to facilitate the reliable maintenance and repair of semiconductor fabrication equipment.

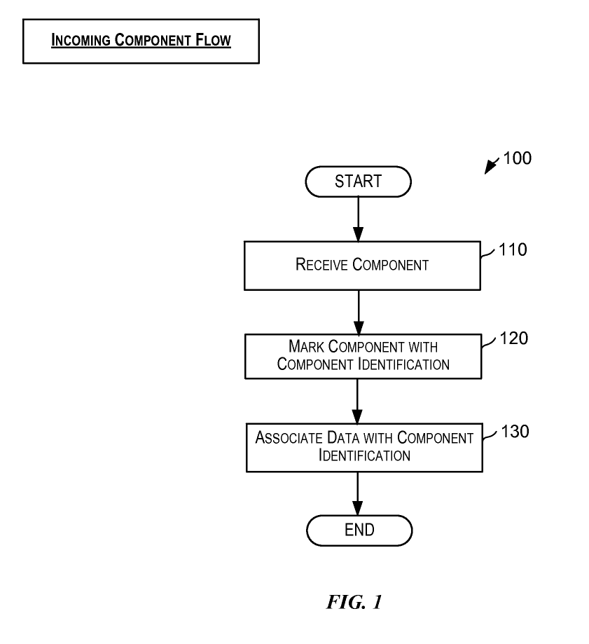

An incoming component process 100 for direct marking and associating data with components is illustrated in FIG. 1. The operations may be performed in any order. In operation 110 the component is received. In some embodiments the component may be manufactured on-site, while in other embodiments the component may be received from a vendor. In operation 120 the component is marked with a unique component identification. In some embodiments the component may have more than one mark while in other embodiments the component may have a single mark. At least one of the marks is a unique mark for that particular component. More specifically, no two components will have the same mark so that each component may be differentiated from others. Myriad methods may be used to mark the component including direct part marking such as, but not limited to, dot peening, laser etching, electro-chemical etching, electro print marking, and/or ink jet printing. Myriad mark types can be made such as, but not limited to, bar codes, dot codes and RFID's. Marking methods and types are explained in more detail below.

In operation 130 data may be associated with the component. In some embodiments, the data associated with the component may include, but not be limited to, component part number, component serial number, component manufacturing lot number, component date code, component manufacturing site, component description, designated equipment model and or serial number for which the component is designed, and component parameters. In further embodiments, the associated data may be stored in a database. The directly marked component may then be stored until it is needed for use on a semiconductor fabrication system.

In some embodiments, directly marked components may be used in a preventative maintenance process 200. The operations may be performed in any order. In operation 210 the component identification may be read from the component. In some embodiments the component identification may be read by a terminal at the installation site. In further embodiments a reading method such as, but not limited to, laser reading, image capture or other may be used as explained in more detail below.

In operation 220 associated data for the component may be retrieved. The associated data may be any data associated with the component such as, but not limited to, component description, component fabrication details, as described in more detail above. In some embodiments, the associated data may be retrieved from a database. In operation 230, equipment identification is read from the semiconductor fabrication system. In some embodiments each piece of equipment may have a unique equipment identification so it can be distinguished from other pieces of equipment. The equipment identification may be read using myriad methods including those described herein.

In operation 240 the directly marked component is installed on the semiconductor fabrication equipment and the component identification is associated with the fabrication tool.

More specifically, in some embodiments, a database may be updated so that the system knows that a specific directly marked component is installed on a specific piece of equipment. In operation 250 input is received corresponding to fabrication tool utilization. In some embodiments, the semiconductor fabrication tool directly communicates the utilization information. In other embodiments, the utilization information may be received manually. In further embodiments, the utilization information may be estimated by, for example, inputting the average utilization rate of the fabrication tool. In some embodiments, the utilization information is input into a terminal that is on the manufacturing site and the data is communicated to a database.

In operation 260 an alert is generated corresponding to an upcoming maintenance requirement. More specifically, in some embodiments, the alert is based upon the fabrication tool utilization employed in operation 250. Based upon the utilization data the expected life of the directly marked component may be determined and an alert sent out before its replacement is required so that catastrophic failure of the component may be avoided. In some embodiments the alert may be generated remotely and communicated to a terminal that communicates to service personnel. In other embodiments, the alert may be remotely generated and communicated to a database which is then in communication with service personnel. In further embodiments, a local terminal may generate the alert and communicate with service personnel.

In further embodiments, directly marked components may be used to repair a semiconductor fabrication tool with a repair and compatibility assessment process 300. The operations may be performed in any order. In operation 310 the component identification may be read from the directly marked component. In some embodiments the component identification may be read by a terminal at the installation site. In further embodiments a reading method such as, but not limited to, laser reading, image capture or other may be used as explained in more detail below.

In operation 320 associated data for the component may be received. The associated data may be any data associated with the component such as, but not limited to, component description, component fabrication details, as described in more detail above. In operation 330 an equipment identification is read from the semiconductor fabrication system. In some embodiments each piece of equipment will have a unique equipment identification so it can be distinguished from other pieces of equipment. The equipment identification may be read using myriad methods, including those described herein.

In operation 340 a compatibility assessment is performed. In some embodiments the compatibility assessment is determined by comparing the associated data from the component to the equipment identification. In some embodiments the compatibility assessment is performed on a local terminal while in other embodiments it may be performed off-site. In further embodiments, in addition to a compatibility assessment, aid with installation of the component may be provided. In other embodiments, the local terminal may display a technical guide or a manual to instruct a technician in the proper installation and/or troubleshoot the system.

In operation 350 the directly marked component is installed on the semiconductor fabrication equipment and the component identification is associated with the fabrication tool. More specifically, in some embodiments a database may be updated so that the system knows that a specific directly marked component is installed on a specific piece of equipment.

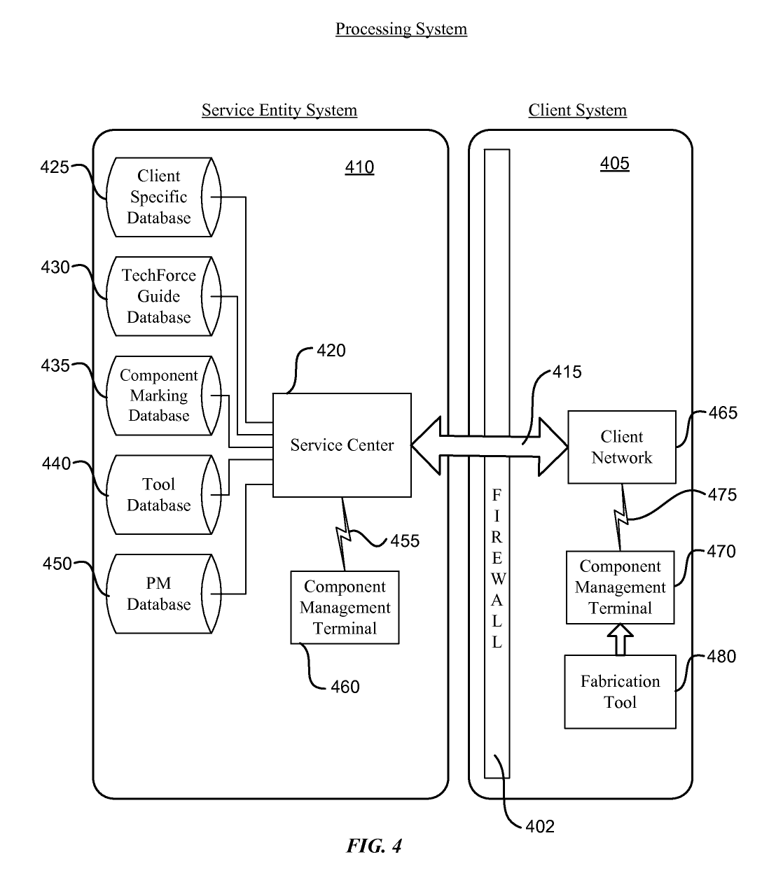

FIG. 4 illustrates an embodiment of the invention that implements the use of a firewall 402 between a client system 405 and a service entity system 410 within a processing system. The processing system may appear as illustrated or may differ in myriad respects. In this embodiment, firewall 402 is illustrated within client system 405, however in other embodiments the firewall may exist elsewhere and in some embodiments there may be no firewall. A data link 415 ties client system 405 to service entity system 410. Data link 415 may be any data link including wired, wireless or a cloud system capable of transferring data between the two systems. A service center 420 may be associated with service entity system 410 and connect multiple data bases including, but not limited to, a customer specific database 425, a TechForce guide database 430, a part marking database 435, a tool database 440, a PM database 450 and/or other databases.

Client specific database 425 may include information about a specific client, their processing tools, their service history and/or their component history among other data. Techforce guide database 430 may store technical guides for any number of semiconductor processing systems. The technical guides may be used to aid in the operation of the equipment, installation of components, the repair of equipment and/or the trouble shooting of equipment. Component marking database 435 may store and correlate a plurality of specific directly marked component numbers with data associated with each of the directly marked component part numbers such as, but not limited to, the component history, the number of cycles the component has been in use, the component part number, component serial number, component manufacturing lot number, component date code, component manufacturing site, component description, designated equipment model and or serial number for which the component is designed, and component parameters.

Tool database 440 may include, for example, data about specific semiconductor manufacturing equipment. In some embodiments this database may contain drawing models of the tool, a parts list, configuration information and other details regarding a specific semiconductor manufacturing tool. This database may be used in conjunction with client specific database 425 and any other database. A preventative maintenance database 450 may store information regarding the life expectancy of particular components, alerts for service personnel, life-time tracking of components installed on specific tools, graphical or other illustrations of preventative maintenance requirements that may be accessed by service entity 410 personnel or client system 405. Other databases may be employed without departing from the invention.

It is also understood that FIG. 4 is only a graphical illustration of a general system and the actual system may differ significantly from the illustration. As an example, databases 425 through 450 may not be separate and their functions may be more or less integrated than shown. The various data within databases 425 through 450 can be accessed by client system 405 through service center 420. For example, client personnel may wish to access a preventative maintenance log for a specific tool. Client personnel may access PM database 450 and tool database 440 through service center 420.

Service center 420 may perform the necessary communications and/or calculations for service entity system 410 to fulfill the requests of client system 405. Service center 420 may also communicate via communication channel 455 with a service center component management terminal 460. Communication channel 455 may be any data link including wired, wireless or a cloud system capable of transferring data between the two systems. Component management terminal 460 may be any type of electronic device including a mobile or stationary input/output device such as a keyboard and monitor, laptop, tablet computer or mobile phone. Databases 425 through 450 may be accessed by component management terminal 460 through service center 420.

As further illustrated in FIG. 4, component management terminal 460, service center 420, and databases 425 through 450 may be on a different network and/or hidden behind firewall 402 from client system 405. Firewall 402 may be used to keep the client's recipes and/or process from being accessed from service entity system 410 side of firewall 402. Firewall 402 may also be used to keep client's from accessing each other's data within databases 425 through 450 or elsewhere.

On the client system 405 side of firewall 402, data link 415 may communicate to client network 465. Client personnel may use component management terminal 470 to communicate via data link 475 to service entity system 410. Component management terminal 470 may be any type of electronic device including a mobile or stationary input/output device such as a keyboard and monitor, laptop, tablet computer or mobile phone. In some embodiments, client's fabrication tool 480 may communicate through client network 465 to service entity system 410. In other embodiments, client personnel may operate a preventative maintenance system on component management terminal 470 for fabrication tool 480. The preventative maintenance system can be loaded with all the necessary data from databases 425 through 450. In particular, this data can be up to date component life expectancy, equipment configuration, and other information that is specific to that client's fabrication tools.

Some embodiments of the invention include a mobile preventative maintenance tool as a component management terminal 470. As an example, a mobile preventative maintenance tool can scan component numbers from the customer's processing tool while in a clean room. Various data about the scanned component can pulled from the component management tool's memory or from databases 425 through 450. Using this data, the preventative maintenance tool can provide data about the component, fabrication tool, recipes, processes, technical guides and other associated information required to properly service the equipment. In this way, analysis and diagnosis of fabrication equipment can occur within the semiconductor fabrication environment. In some embodiments, the scanner may be separate from the component management terminal 470 and may be wirelessly coupled with or wired to the component management terminal. A mobile preventative maintenance tool may include secure wireless connectivity that can include WiFi, 4G, 3G, Bluetooth, or other protocols.

In some embodiments, a preventative maintenance tool can maintain a log of the various components used within a specific semiconductor processing tool at a specific customer location. This log can include the components in use within the specific tool, the amount of time each component has been in use, the number of processing cycles the component has been used within the semiconductor processing tool, project name or identifier, listing of components used within the processing tool, recipes, the representative that serviced the semiconductor processing tool the last time it was serviced and the date of the last service among other information. The log can be stored on the specific preventative maintenance tool and/or on a secure server that can be accessed by the component management tool. In some embodiments the secure server may exist within service entity system 410 while in other embodiments it may exist within client system 405. Moreover, the cycle data in the log can indicate the number of cycles the various components were used for various process such as processing ceramic, quartz, metal or other. The log may also indicate the number of cycles the component was used with specific chemicals or plasmas and/or at specific high or low temperatures, among other information.

In some embodiments of the invention the preventative maintenance system can include a touch-type tablet computer, which may include an optical camera, software that runs on the tablet, and/or an RFID fob. The software may perform any process, method, step or operation described herein. The RFID fob can be used to scan RFID tagged chambers, tools or components and/or can relay data to the tablet. The RFID fob can be wired or wirelessly (e.g., Bluetooth®) coupled with the tablet. In some embodiments the tablet can be used without RFID; the barcode can be used in its place in event that RFID fob ceases to function and/or becomes lost.

In some embodiments, the preventative maintenance system can provide for enhanced kitting. This can include, configurable local kitting with integrated components data. This may enable reliability tracking and TKM data tracking. The preventative maintenance system may further provide preventative maintenance scheduling with integrated components data, component reliability tracking and reporting, as well as predictive component tracking

### Methods of Making and Reading Direct Component Markings

Various methods of direct component marking techniques may be used on components. Dot Peening is one example of a direct component marking technique. Dot peening can be achieved by pneumatically or electromechanically striking a carbide- or diamond-tipped stylus against the surface of the material being marked. Reading solutions utilize lighting techniques to create contrast between the indentations forming the modules of the symbol and the surface of the component. Therefore, the quality of the indented dots can be very important to the readability of the code.

Laser marking is another example of a direct component marking technique. This technique applies heat to the surface of a component that causes the surface of the component to melt, vaporize or change in some way in order to produce a mark. The resulting quality of the mark depends upon the interaction of the laser with the material it is marking. A laser can produce both round and square modules; typically, the laser is used to produce a square module and continuous finder pattern for higher density (large data capacity) codes. The laser marking process can offer high speed, consistency, and high precision. Laser marking is widely used in the semiconductor, electronics, and medical device industries.

Electro-chemical etching (ECE) is another example of a direct component marking technique. This is a process whereby a mark is produced from oxidation of metal from the surface being marked through a stencil impression. This is achieved by sandwiching a stencil between the surface being marked and an electrolyte soaked pad, and passing a low voltage current between the two. ECE is recommended for round surfaces and for stress-sensitive components. ECE is used for marking certain components of jet engines, automobiles, and medical devices.

Ink-jet printers is yet another example of a direct component marking technique. Precisely propelled ink drops impinge the component surface, after which the carrier fluid that makes up a portion of the ink dot evaporates, leaving a colored die on the surface of the component creating the pattern of modules that make up the mark. The application of ink jet marking may require preparation of the component surface, as it is the chemical interaction of the ink to the surface of the component that determines the level of mark permanence and contrast Ink jet marking provides fast marking of moving components, and offers very good contrast.

Myriad other methods of marking components may be used without departing from the invention. In other embodiments, for example, labels or tags may be affixed to components. In further embodiments an RFID tag or other device may be affixed to a component.

The direct marking of components may be performed in myriad ways without departing from the invention. In some embodiments a barcode may be used to directly mark the components. A barcode is an optical representation of data. In some embodiments barcodes systematically represent data by varying the widths and spacings of parallel lines, and may be referred to as linear or one-dimensional (1D). In other embodiments two-dimensional (2D) barcodes may be used that include rectangles, dots, hexagons and other geometric patterns. In further embodiments an RFID may be affixed to the component. Other methods of marking may be used without departing from the invention.

Myriad methods may be employed to read the marks on directly marked components without departing from the invention. In some embodiments a laser or light may be used. In other embodiments an image of the mark may be captured and digitally analyzed. In other embodiments an RF signal may be used to access data from an RFID tag.

### Implementation on a Computing Device

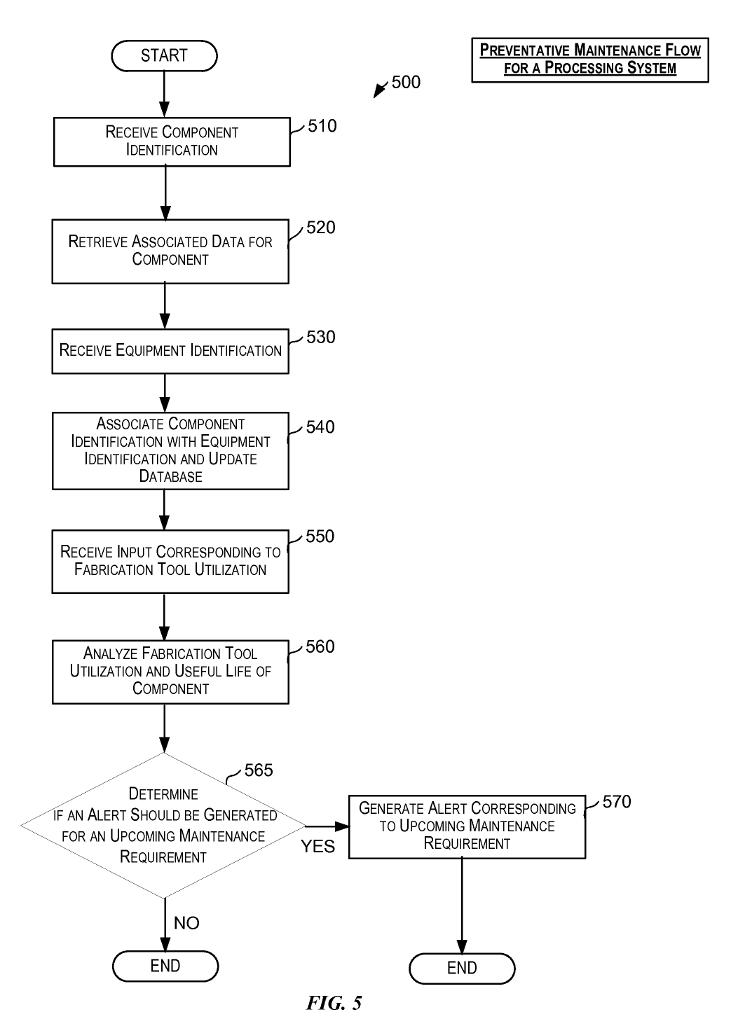

FIG. 5 depicts a simplified flowchart 500 illustrating a general method for component management terminal 470 (see FIG. 4) to perform a preventative maintenance process for a semiconductor fabrication system. The processing depicted in FIG. 5 may be implemented in software (e.g., code, instructions, program) executed by one or more processors, in hardware, or combinations thereof. The software may be stored on a non-transitory computer-readable storage medium (e.g., stored on a memory device). The particular series of processing steps depicted in FIG. 5 is not intended to be limiting. In some embodiments a computing system such as, but not limited to, the system illustrated in FIG. 4 may be employed.

As depicted in FIG. 5, the method may be initiated at operation 510 upon receiving a component for the repair or maintenance of a semiconductor fabrication tool. Component management terminal 470 may receive a component identification. In some embodiments, the component identification may be read by a sensor that transfers information to component management terminal 470. In further embodiments a reading method such as, but not limited to, laser reading, image capture or other may be used as explained in more detail herein. At operation 520 component management terminal may retrieve associated data for the component. In some embodiments, retrieval of the associated data may be performed in response to receiving the component identification in operation 510. The associated data may be any data associated with the component such as, but not limited to, component description, component fabrication details, as described in more detail herein. In some embodiments, the associated data may be retrieved from one or more databases.

In operation 530 component management terminal may receive an equipment identification associated with the semiconductor fabrication system. In some embodiments each semiconductor fabrication system may have a unique equipment identification so it can be distinguished from other pieces of equipment. In some embodiments, the equipment identification may be read by a sensor that transfers information to component management terminal 470. In further embodiments a reading method such as, but not limited to, laser reading, image capture or other may be used as explained in more detail herein.

In operation 540 the component identification may be associated with the equipment identification and one or more databases updated. More specifically, in some embodiments, one or more databases may be updated so that the computing system knows that a specific directly marked component is installed on a specific piece of equipment. In further embodiments, the association may be performed in response to receiving the equipment identification or receiving the component identification in operations 530 and 510, respectively. Component management terminal 470 may perform the updating operation, or the operation may be performed remotely. In some embodiments, component management terminal 470 may indicate that the association has taken place, while in other embodiments a user may interact with the component management terminal to execute the association.

In operation 550 input is received corresponding to fabrication tool utilization. In some embodiments, the semiconductor fabrication tool directly communicates the utilization information to the computing system. In other embodiments, the utilization information may be received manually. In some embodiments the utilization information may be manually entered into component management terminal 470. In further embodiments, the utilization information may be estimated by, for example, inputting the average utilization rate of the fabrication tool. In some embodiments, the utilization information is input into a terminal that is on the manufacturing site and the data is communicated to one or more databases.

In operation 560 the fabrication tool utilization information is analyzed and compared to the useful life of the component. In some embodiments the analysis may be performed in response to receiving input corresponding to fabrication tool utilization in operation 550. In other embodiments the analysis may be performed on a routine and repetitive basis or in response to a request. In further embodiments the useful life of the component may be extracted from one or more databases. In one embodiment the useful life is retrieved from a component marking database having data associated with the component. In further embodiments the computing system determines an estimated time when the fabrication tool utilization will be equivalent to the estimated useful life of the component.

In operation 565 a determination is made based on the analyses performed in operation 560. In some embodiments, the determination may be performed in response to the analysis performed in operation 560. In further embodiments, the determination may be based upon the fabrication tool utilization received in operation 550. Thus, in some embodiments, the expected life of the directly marked component may be determined to be within a predetermined period of time based upon the utilization data, and replacement of the component may be required so that catastrophic failure of the component may be avoided. Therefore, if certain parameters are met, for example, that an upcoming maintenance requirement is within a certain predetermined time period, the system may proceed to operation 570 to send an alert. However, if certain parameters are not met, the system may not proceed to step 570.

In operation 570 an alert may be generated by the computing system corresponding to an upcoming maintenance requirement corresponding to the end of the useful life of the component. In some embodiments the alert may be generated remotely and communicated to component management terminal 470 that communicates to service personnel. In further embodiments the alert may be generated in response to performing the analysis in operation 560. In other embodiments, the alert may be remotely generated and communicated to a database which is then in communication with service personnel. In further embodiments, a local terminal may generate the alert and communicate with service personnel.

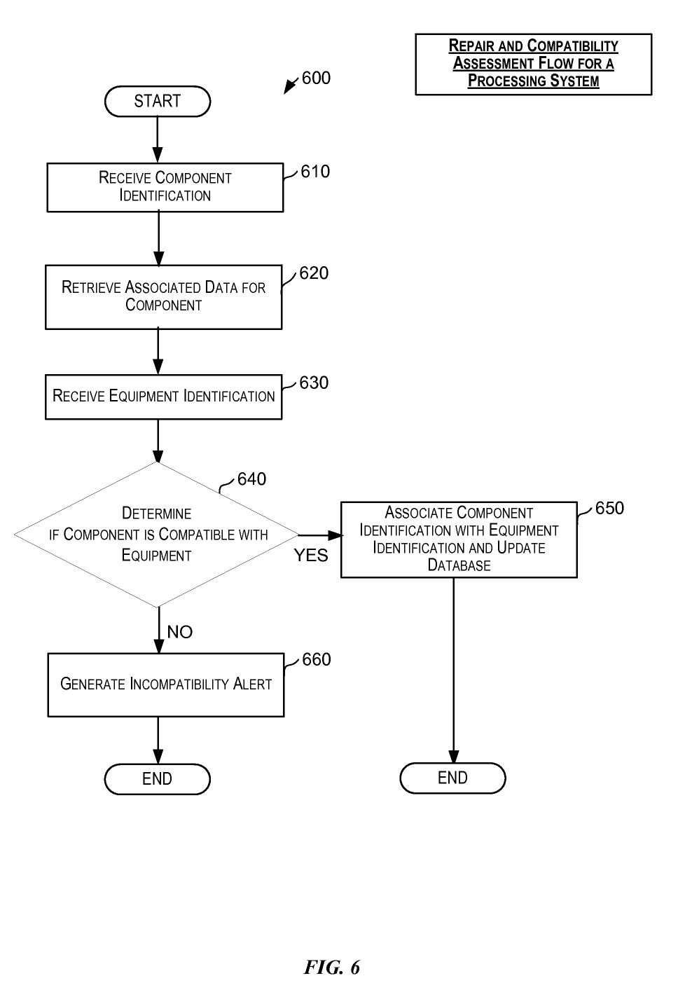

FIG. 6 depicts a simplified flowchart 600 illustrating a general method for component management terminal 470 (see FIG. 4) to perform a repair and compatibility assessment process for a semiconductor fabrication system. The processing depicted in FIG. 6 may be implemented in software (e.g., code, instructions, program) executed by one or more processors, in hardware, or combinations thereof. The software may be stored on a non-transitory computer-readable storage medium (e.g., stored on a memory device). The particular series of processing steps depicted in FIG. 6 is not intended to be limiting. In some embodiments a computing system such as, but not limited to, the system illustrated in FIG. 4 may be employed.

As depicted in FIG. 6, the method may be initiated at operation 610 upon receiving a component for the repair or maintenance of a semiconductor fabrication tool. In one embodiment, component management terminal 470 may receive a component identification. In some embodiments, the component identification may be read by a sensor that transfers information to component management terminal 470. In further embodiments a reading method such as, but not limited to, laser reading, image capture or other may be used as explained in more detail herein. At operation 620 component management terminal may retrieve associated data for the component. In some embodiments, retrieval of the associated data may be performed in response to receiving the component identification in operation 610. The associated data may be any data associated with the component such as, but not limited to, component description, component fabrication details, as described in more detail herein. In some embodiments, the associated data may be retrieved from one or more databases.

In operation 630 component management terminal may receive an equipment identification associated with the semiconductor fabrication system. In some embodiments each semiconductor fabrication system may have a unique equipment identification so it can be distinguished from other pieces of equipment. In some embodiments, the equipment identification may be read by a sensor that transfers information to component management terminal 470. In further embodiments a reading method such as, but not limited to, laser reading, image capture or other may be used as explained in more detail herein.

In operation 640 a determination is made as to whether the component is compatible with the equipment. A compatibility assessment may be performed by the computing system. In some embodiments the assessment may be performed in response to receiving the component identification or receiving the equipment identification performed in operations 610 and 630, respectively. In one embodiment data associated with the component identification is compared to data associated with the equipment identification. The data may be retrieved from one or more databases and/or input by a user. Compatibility analyses may be based on any component and equipment data including that mentioned herein. If the component is determined to be compatible with the equipment the system proceeds to operation 650. However, if the component is determined to be incompatible with the equipment, the system proceeds to operation 660.

In operation 650 the component identification may be associated with the equipment identification and one or more databases updated. More specifically, in some embodiments, one or more databases may be updated so that the computing system knows that a specific directly marked component is installed on a specific piece of equipment. In other embodiments, the association may be performed in response to the assessment performed in operation 640. In further embodiments, only after the component is determined to be compatible with the equipment will the association within the database take place. Component management terminal 470 may perform the updating operation, or the operation may be performed remotely. In some embodiments, component management terminal may indicate that the association has taken place, while in other embodiments a user may interact with the component management terminal to execute the association.

In operation 660 an incompatibility alert is generated. In some embodiments the alert may be generated remotely and communicated to component management terminal 470 that communicates to service personnel. In other embodiments, the alert may be remotely generated and communicated to a database which is then in communication with service personnel. In further embodiments, a local terminal may generate the alert and communicate with service personnel.

### Advantages

Embodiments of the invention can provide a number of advantages. One advantage may be an all-in-one user interface for semiconductor fabrication tool service that minimizes the risk of installation of the incorrect component or incorrectly installing components. Another advantage is that customers may be able to effectively and accurately track component usage/life within their tools/chambers to the point that maintenance can be scheduled on a predictive and timely basis versus purely on calendar basis which may occur when components do not necessarily have to be replaced and/or when a tool goes down.

Another advantage is that components with direct marking can allow for instant identification of chamber components via optical camera interface on tablet. Component information such as serial number, component number, and/or descriptions can be instantly available to the component management tool. This can help avoid the possibility of using incorrect components on a specific fabrication tool. In some embodiments, the tablet may maintain a database of components used on a specific fabrication tool, which can be synchronized to a central database.

Another advantage includes having pictures of each chamber component available to service personnel on the screen of the component management tool. The picture of a component can be accessed based on the component number and/or on the location of the component within the tool. This can further verify identity of desired component being installed.

Another advantage can include having technical guides pre-loaded on the component management tool or readily accessible. These guides can be accessed by the preventative maintenance tool user and may be used, for example, when a question of installation and/or best known method arises. With the technical guide loaded on the component management tool, there should be no need to seek a PC station or stop work to look up a procedure.

Another advantage includes a lower cost of fabrication tool ownership due to properly maintained fabrication tools and/or good condition components being utilized versus worn and/or incorrect components that can potentially cause tool to malfunction or go down. Fabrication tool owners that utilize a service organization using the preventative maintenance tool should be able to maximize tool uptime and/or full component utilization.

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Different arrangements of the components depicted in the drawings or described above, as well as components and steps not shown or described are possible. Similarly, some features and sub combinations are useful and may be employed without reference to other features and sub combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

A computational system can be used to perform any of the embodiments of the invention. For example, the computational system can be used to execute methods and/or processes that utilize directly marked components. As another example, the computational system can be used perform any calculation, identification and/or determination described here. The computational system includes hardware elements that can be electrically coupled via a bus (or may otherwise be in communication, as appropriate). The hardware elements can include one or more processors, including without limitation one or more general-purpose processors and/or one or more special-purpose processors (such as digital signal processing chips, graphics acceleration chips, and/or the like); one or more input devices, which can include without limitation a mouse, a keyboard and/or the like; and one or more output devices, which can include without limitation a display device, a printer and/or the like.

The computational system may further include (and/or be in communication with) one or more storage devices, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system might also include a communications subsystem, which can include without limitation a modem, a network card (wireless or wired), an infrared communication device, a wireless communication device and/or chipset (such as a Bluetooth device, an 802.6 device, a WiFi device, a WiMax device, cellular communication facilities, etc.), and/or the like. The communications subsystem may permit data to be exchanged with a network (such as the network described below, to name one example), and/or any other devices described herein. In many embodiments, the computational system will further include a working memory, which can include a RAM or ROM device, as described above.

The computational system also can include software elements, including an operating system and/or other code, such as one or more application programs, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) described above.

In some cases, the storage medium might be incorporated within the computational system or in communication with the computational system. In other embodiments, the storage medium might be separate from a computational system (e.g., a removable medium, such as a compact disc, etc.), and/or provided in an installation package, such that the storage medium can be used to program a general purpose computer with the instructions/code stored thereon.

These instructions might take the form of executable code, which is executable by the computational system and/or might take the form of source and/or installable code, which, upon compilation and/or installation on the computational system (e.g., using any of a variety of generally available compilers, installation programs, compression/decompression utilities, etc.) then takes the form of executable code.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method for managing preventative maintenance periods for semiconductor manufacturing equipment, the method comprising:
receiving, from a first sensor in communication with a processing system, a component identification from a component;
retrieving, using the processing system, associated data from a database for the component;
receiving, from a second sensor in communication with the processing system, an equipment identification from the semiconductor fabrication equipment;
associating, using the processing system, the component identification with the equipment identification within a database;
receiving input into the processing system, the input corresponding to a usage rate of the semiconductor fabrication equipment;
analyzing, with the processing system, the usage rate of the semiconductor fabrication equipment and a useful life of the component; and
determining, with the processing system, if an alert corresponding to an upcoming maintenance requirement should be generated based upon the analyzing.

2. The method of claim 1 wherein the first and the second sensor are the same sensor.

3. The method of claim 1 wherein the receiving input into the processing system comprises receiving data directly from the semiconductor fabrication equipment.

4. The method of claim 1 wherein the first sensor is in communication with a component management terminal.

5. The method of claim 4 wherein the first sensor is an image capture device.

6. The method of claim 1 wherein the analyzing comprises determining a replacement date for the component based on the usage rate of the semiconductor fabrication equipment.

7. The method of claim 1 wherein the determining comprises comparing an estimated replacement date for the component to a predetermined time period.

8. The method of claim 1 wherein the alert comprises an email.

9. The method of claim 1 wherein the alert comprises an audible or visible indication.

10. A non-transitory computer-readable storage medium storing a plurality of instructions for controlling a processor, the plurality of instructions comprising:
instructions that cause the processor to receive a component identification from a first sensor;
instructions that cause the processor to retrieve associated data from a database for the component;
instructions that cause the processor to receive an equipment identification from a second sensor;
instructions that cause the processor to associate the component identification with the equipment identification within a database;
instructions that cause the processor to receive input corresponding to a usage rate of the equipment;
instructions that cause the processor to analyze the usage rate of the equipment and a useful life of the component;
instructions that cause the processor to determine if an alert corresponding to an upcoming maintenance requirement should be generated based upon the analyzing; and
instructions that cause the processor to generate an alert in response to the analyzing, the alert corresponding to an upcoming maintenance requirement associated with the component.

11. A system for managing preventative maintenance periods for semiconductor manufacturing equipment, the system comprising:
a memory storing a plurality of instructions; and
a processor coupled to the memory, the processor configured to execute the plurality of instructions to:
receive, from a first sensor, a component identification from a component;
retrieve associated data from a database for the component;
receive, from a second sensor, an equipment identification from the semiconductor fabrication equipment;
associate the component identification with the equipment identification within a database;
receive input corresponding to a usage rate of the semiconductor fabrication equipment;
analyze the usage rate of the semiconductor fabrication equipment and a useful life of the component; and
determine if an alert corresponding to an upcoming maintenance requirement should be generated based upon the analyzing.

12. A system for checking the compatibility of components and tracking components installed on a semiconductor manufacturing equipment, the system comprising:
a memory storing a plurality of instructions; and
a processor coupled to the memory, the processor configured to execute the plurality of instructions to:
receive, from a first sensor, a component identification from a directly marked component;
retrieve associated data for the component from a database;
receive, from a second sensor, an equipment identification from the semiconductor fabrication equipment;
determine compatibility of the component and the semiconductor fabrication equipment; and
associate the component with the semiconductor fabrication equipment if the component is compatible with the semiconductor fabrication equipment.

13. The system of claim 12 further comprising initiating a preventative maintenance program after the associating.

14. The system of claim 13 wherein the preventative maintenance program generates an alert corresponding to an upcoming maintenance requirement associated with the component.

15. The system of claim 12 wherein the first sensor is integrated in a component management terminal.

16. The system of claim 12 wherein the first sensor is an image capture device.

17. The system of claim 12 wherein a component management terminal communicates the component identification through a firewall to a database.

18. The system of claim 17 wherein the component management terminal comprises a wireless tablet.

19. The system of claim 12 wherein the second sensor comprises an RFID system.

20. The system of claim 12 wherein after the determining compatibility, a component management terminal notifies a technician whether or not the component is compatible with the semiconductor fabrication equipment.
